(19) United States
(12) Patent Application Publication
(10) Pub. No.: US 2015/0160751 A1
(43) Pub. Date: Jun. 11, 2015

(54) INPUT DEVICE AND METHOD OF DETECTING LOAD AT PLURALITY OF POINTS USING INPUT DEVICE

(71) Applicant: ALPS ELECTRIC CO., LTD., Tokyo (JP)

(72) Inventors: Masahiko ISHIZONE, Niigata-ken (JP); Eiji UMETSU, Niigata-ken (JP); Takashi SATO, Niigata-ken (JP); Hiroyuki MORIOKA, Niigata-ken (JP); Yukimitsu YAMADA, Niigata-ken (JP)

(21) Appl. No.: 14/625,476

(22) Filed: Feb. 18, 2015

Related U.S. Application Data
(63) Continuation of application No. PCT/JP2013/077563, filed on Oct. 10, 2013.

(30) Foreign Application Priority Data
Oct. 11, 2012 (JP) 2012-225837

(51) Int. Cl. G06F 3/041

(52) U.S. Cl. CPC G06F 3/041

(57) ABSTRACT

An input device includes a capacitive touch panel sensor capable of detecting a pressing position on an operation surface, a plurality of load sensors configured to output a sensor output depending on a load, and a control unit configured to calculate respective loads at a plurality of pressing points simultaneously pressed on the operation surface. In particular, it is possible to obtain the load of each pressing point even when the number of a plurality of simultaneously pressed pressing points is equal to the number of load sensors.

### CLAIM OF PRIORITY

This application is a Continuation of International Application No. PCT/JP2013/077563 filed on Oct. 10, 2013, which claims benefit of Japanese Patent Application No. 2012-225837 filed on Oct. 11, 2012. The entire contents of each application noted above are hereby incorporated by reference.

### BACKGROUND OF THE INVENTION

1. Field of the Invention

The present invention relates to an input device mounted on a portable device or another electronic device and operated by causing a finger or the like to come into contact with an operation panel.

2. Description of the Related Art

An input device capable of detecting a position coordinate and a load of a pressing point when an operation surface is operated with a finger or the like is described in Japanese Unexamined Patent Application Publication Nos. 2009-87311, 2010-146206, 2010-211399, and 2010-244514 shown below.

In these Patent Literatures, the number of pressing points in which both the position coordinate and the load are able to be detected is 1, and detection of a load at each pressing point when a plurality of points are simultaneously pressed is not described.

Further, Japanese Unexamined Patent Application Publication Nos. 2010-272143, 11-212725, and 62-172420 disclose a configuration in which a load sensor is arranged under an operation surface. Also, sensitivity of the load sensor is described in these Patent Literatures. However, detection of a load of each pressing point when the operation surface is simultaneously pressed at a plurality of positions is not described, similarly to Japanese Unexamined Patent Application Publication Nos. 2009-87311, 2010-146206, 2010-211399, and 2010-244514.

### SUMMARY OF THE INVENTION

The present invention provides an input device capable of obtaining each load of a plurality of simultaneously pressed pressing points without performing a complicated calculation even when a plurality of points are simultaneously pressed, and a method of detecting a load at a plurality of points using the input device.

According to an aspect of the present invention, an input device includes a position detection sensor capable of detecting a pressing position on an operation surface, a plurality of load sensors configured to output a sensor output depending on a load, and a control unit configured to calculate respective loads at a plurality of pressing points simultaneously pressed on the operation surface through the following process:

(1) calculating sensitivity at a plurality of different reference points on the operation surface from the sensor output of each load sensor, and holding the sensitivity,

(2) obtaining the sensor output from each load sensor and detecting a position coordinate of each pressing point from the position detection sensor when the operation surface is simultaneously pressed at the plurality of pressing points,

(3) obtaining position rates of each pressing point within a region surrounded by the plurality of reference points close to each pressing point based on the position coordinates of each pressing point and each reference point,

(4) obtaining the sensitivity of each pressing point based on the sensitivity of each reference point used in (3) and the position rates of each pressing point, and

(5) calculating the load of each pressing point based on the sensitivity of each pressing point obtained in (4) and the sensor output of each load sensor obtained in (2).

Further, according to another aspect of the present invention, a method of detecting a pressing point in an input device including a position detection sensor capable of detecting a pressing position on an operation surface, a plurality of load sensors configured to output a sensor output depending on a load, and a control unit configured to calculate respective loads at a plurality of pressing points simultaneously pressed on the operation surface, the method including steps of:

(1) calculating sensitivity at a plurality of different reference points on the operation surface from the sensor output of each load sensor, and holding the sensitivity;

(2) obtaining the sensor output from each load sensor and detecting a position coordinate of each pressing point from the position detection sensor when the operation surface is simultaneously pressed at the plurality of pressing points;

(3) obtaining, in the control unit, position rates of each pressing point within a region surrounded by the plurality of reference points close to each pressing point based on the position coordinates of each pressing point and each reference point;

(4) obtaining, in the control unit, the sensitivity of each pressing point based on the sensitivity of each reference point used in (3) and the position rates of each pressing point; and

(5) calculating, in the control unit, the load of each pressing point based on the sensitivity of each pressing point obtained in (4) and the sensor output of each load sensor obtained in (2).

In the aspect of the present invention, the sensitivities at the plurality of reference points in the operation surface are held in advance as shown in (1), and when the plurality of points (a plurality of pressing points) are simultaneously pressed on the operation surface, the sensor output of each load sensor and the position coordinate of each pressing point are first detected in (2), and then, the position rates of each pressing point within the region surrounded by a plurality of reference points close to each pressing point are obtained in (3). The position rate can be obtained based on the position coordinate at each pressing point and each reference point. Then, in (4), the sensitivity of each pressing point is obtained based on the sensitivity of each reference point and the position rate of each pressing point. Also, in (5), the load of each pressing point can be calculated based on the sensitivity of each pressing point and the sensor output of the load sensor.

According to an aspect of the present invention, it is possible to appropriately and simply obtain the loads of the plurality of simultaneously pressed pressing points without using a complicated calculation.

Particularly, according to the input device and the method of detecting a pressing point in the aspect of the present invention, it is possible to obtain the load of each pressing point even when the number of a plurality of simultaneously pressed pressing points is equal to the number of load sensors. That is, it is possible to obtain the load of each pressing point, for example, if the number of simultaneously pressed pressing points is equal to or smaller than 4 when four load sensors are provided.

In the aspect of present invention, it is preferable that, in an XY coordinate system, each lattice point obtained through crossing in an X direction and an Y direction is the reference point, and in (3), a position rate u in the X direction and a position rate v in the Y direction of each pressing point within a smallest lattice surrounded by four reference points close to each pressing point are obtained. Accordingly, it is possible to reduce a sensitivity error at each pressing point and to accurately obtain the load of each pressing point.

In the aspect of present invention, it is preferable for 4 or more load sensors to be provided. Accordingly, it is possible to obtain the load of each pressing point even when the number of simultaneously pressed pressing points is 4 or more, which is equal to the number of load sensors.

### BRIEF DESCRIPTION OF THE DRAWINGS

FIG. 1 is a plan view of an input device in this embodiment;

FIG. 2 is a partial longitudinal sectional view of the input device in the embodiment of the present invention;

FIG. 3 is a block diagram of the input device of this embodiment;

FIGS. 4A and 4B are illustrative diagrams of a load sensor, FIG. 4A is a partial longitudinal sectional view, and FIG. 4B is a back surface perspective view of a sensor substrate constituting the load sensor;

FIG. 5 is a schematic view illustrating a plurality of reference points and a plurality of pressing points in this embodiment;

FIG. 6 is a schematic view illustrating a pressing point and four reference points (lattice points) surrounding the pressing point; and

FIG. 7A is a flowchart of calibration of the input device in this embodiment, and FIG. 7B is a flowchart diagram illustrating a method of detecting a pressing point using the input device in this embodiment.

### DESCRIPTION OF THE PREFERRED EMBODIMENTS

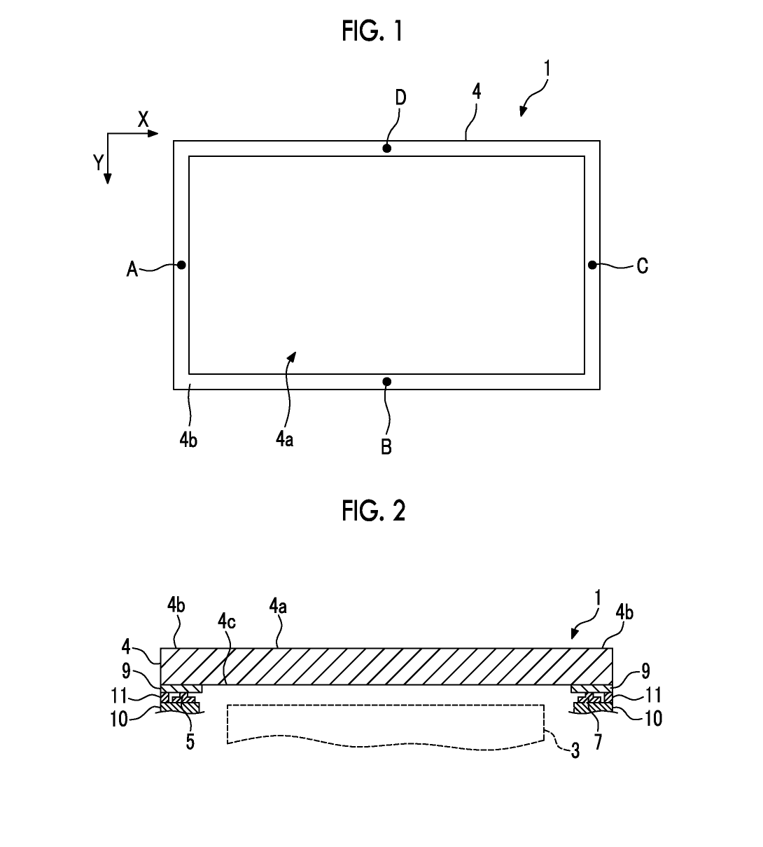

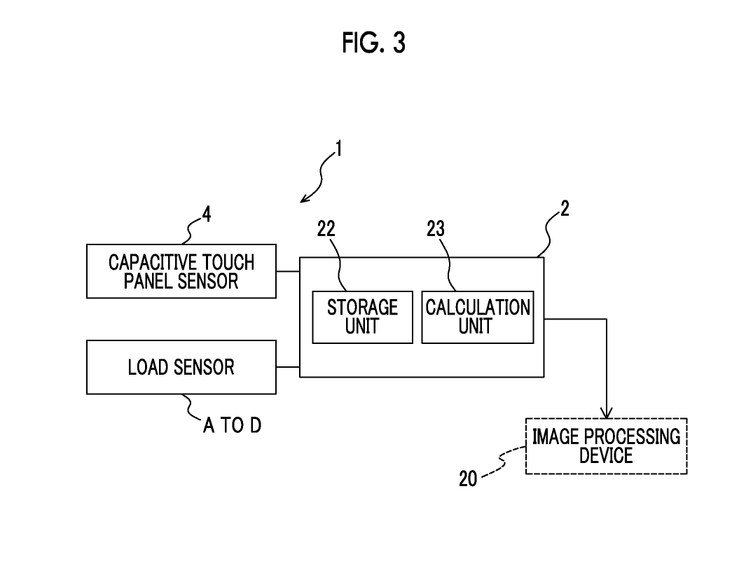

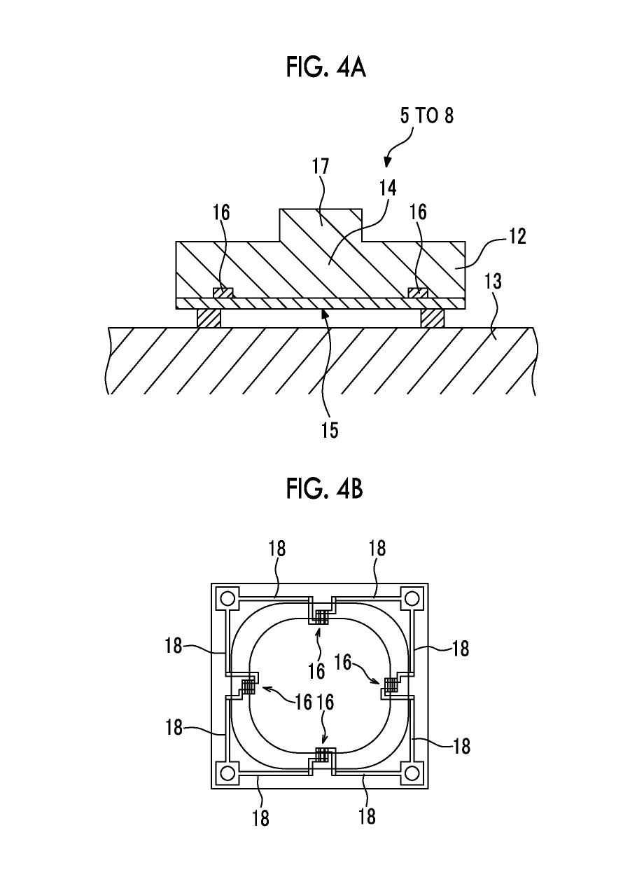

FIG. 1 is a plan view of an input device in this embodiment, FIG. 2 is a partial longitudinal sectional view of the input device in the embodiment of the present invention, FIG. 3 is a block diagram of the input device of this embodiment, FIGS. 4A and 4B are illustrative diagrams of a load sensor, FIG. 4A is a partial longitudinal sectional view, and FIG. 4B is a back surface perspective view of a sensor substrate constituting the load sensor.

An input device 1 in this embodiment includes a capacitive touch panel sensor 4, and a plurality of load sensors A to D provided on a back surface 4c of the capacitive touch panel sensor 4.

The capacitive touch panel sensor 4 includes an operation panel formed of light transmitting glass or plastic, and a light transmitting sensor layer provided on a back surface of the operation panel. A surface of the capacitive touch panel sensor 4 is an operation surface 4a.

When the operation surface 4a of the capacitive touch panel sensor 4 is pressed with an operation body such as a finger, a change in capacitance occurs and a pressing position (operation position) of the operation body is able to be detected based on the capacitance change. In the capacitive touch panel sensor 4, even when a plurality of points on the operation surface 4a are simultaneously pressed, an X coordinate and a Y coordinate of each pressing point are able to be detected based on the capacitance change described above. Further, a resistive film type or the like may be used in place of the capacitive type. In the case of the resistive film type, for example, a resistance layer of the same plane is divided into a plurality of portions, and when a plurality of points are simultaneously pressed, position coordinates of the respective pressing points are able to be simultaneously detected. However, with the capacitive type, when a plurality of points are simultaneously pressed, it is possible to detect respective position coordinates of a plurality of pressing points more accurately.

As illustrated in FIG. 2, a decorative layer 9 is provided on the back surface 4c in a peripheral portion 4b of the capacitive touch panel sensor 4, and thus, displaying of a liquid crystal display (LCD) 3 is performed through the light transmitting capacitive touch panel sensor 4 at a central portion of the capacitive touch panel sensor 4, and an input operation on the operation surface 4a is enabled. Further, the peripheral portion 4b of the capacitive touch panel sensor 4 is a frame-shaped opaque decorative region, and the load sensors A to D provided in the decorative region are not seen from the operation surface 4a side.

Each of the load sensors A to D includes a sensor substrate 12, and a base surface 13, as illustrated in FIGS. 4A and 4B. A displacement portion 14, and a projection-shaped pressure reception portion 17 that projects in a determination direction of the base surface 13 are provided in the sensor substrate 12. A predetermined space portion 15 is formed between the sensor substrate 12 and the base surface 13, and accordingly, the displacement portion 14 is able to be displaced in a height direction when the displacement portion 14 receives a load. A plurality of piezoresistive elements 16 are provided as distortion detection elements in a back surface of the sensor substrate 12, as illustrated in FIGS. 4A and 4B. When the displacement portion 14 is displaced in the height direction due to the load received by the pressure reception portion 17, resistance of each piezoresistive element 16 is changed according to a displacement amount, a middle point potential of a bridge circuit including the respective piezoresistive elements 16 is changed, and thus, a sensor output can be obtained. A wiring portion 18 drawn from each piezoresistive element 16 as illustrated in FIG. 4B is electrically connected to a pad portion (not illustrated).

The load sensors A to D in this embodiment may have a configuration other than the configuration illustrated in FIGS. 4A and 4B. For example, the load sensor can have a configuration in which when the operation surface 4a is pressed, capacitance is changed based on a change in the distance between the two electrodes, and a load is able to be detected based on this capacitance change. Further, the load sensors A to D illustrated in FIGS. 4A and 4B may be installed in a state in which the pressure reception portion 17 is directed upward.

As illustrated in FIGS. 1 and 2, the load sensors A to D are arranged on the back surface 4c side of the capacitive touch panel sensor 4. Further, a support portion 10 that supports the load sensors A to D is included, and this support portion 10 and the capacitive touch panel sensor 4 are connected by a connection portion 11 that is deformable in a height direction, as illustrated in FIG. 2. Accordingly, when the operation surface 4a is pressed, the capacitive touch panel sensor 4 is moved downward and is able to apply a load to the load sensors A to D. The connection portion 11 is, for example, a double-sided tape. Further, a configuration in which an elastic body such as a rubber is interposed between the capacitive touch panel sensor 4 and the load sensors A to D may be adopted.

Further, a support structure of the load sensors A to D in the touch panel 1 is not limited to the structure illustrated in FIG. 2. Further, positions of the load sensors A to D in the touch panel 1 are not limited to those illustrated in FIG. 1 (cross arrangement) and may be arranged, for example, at four corners.

The input device 1 of this embodiment includes a capacitive touch panel sensor 4, a plurality of load sensors A to D, and a control unit (IC) 2 connected to the capacitive touch panel sensor 4 and the respective load sensors A to D, as illustrated in FIG. 3. Further, data from the control unit 2 is able to be transmitted to an image display device 20 such as a liquid crystal display (LCD) 3 of a device body portion.

The control unit 2 includes a storage unit 22 and a calculation unit 23, as illustrated in FIG. 3. Information obtained by calibration, outputs from the capacitive touch panel sensor 4 and the load sensors A to D, and the like are able to be stored in the storage unit 22.

Further, the calculation unit 23 is able to calculate, for example, each load of each pressing point when the plurality of points on the operation surface 4a are simultaneously pressed.

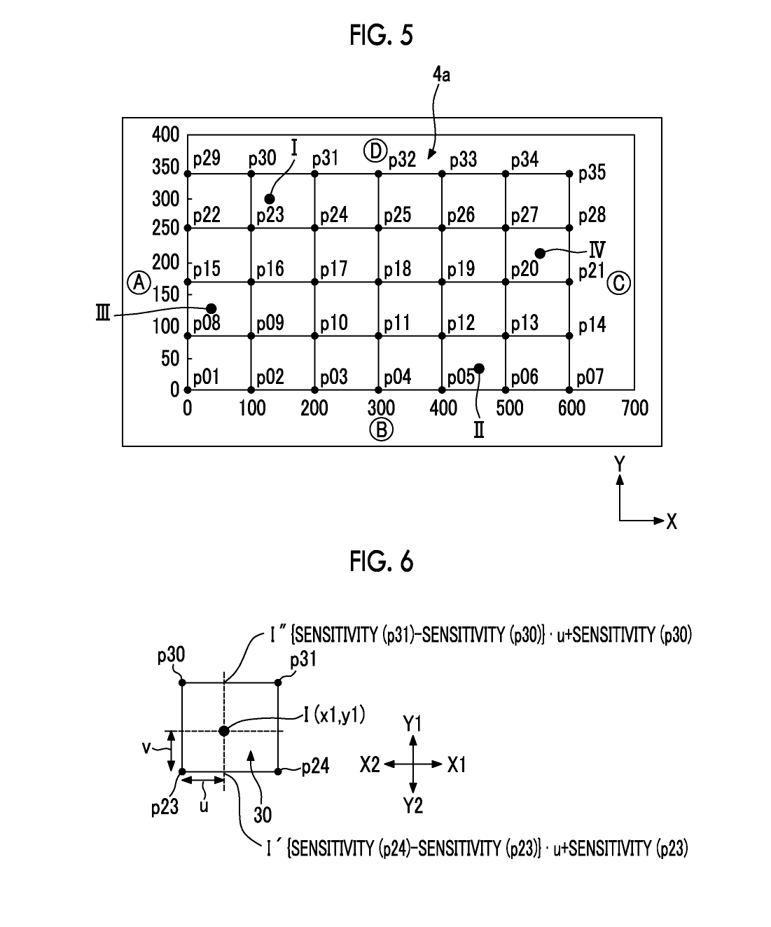

Hereinafter, an algorithm for obtaining loads of respective pressing points that have been simultaneously pressed will be described using FIGS. 5 to 7. Further, in this description, specific numerical values are used as shown in Tables 1 to 8.

First, calibration is performed. However, the operation surface 4a is divided in a lattice form in an XY coordinate system, as illustrated in FIG. 5. Also, respective lattice points which are points crossing in X and Y directions are reference points p01 to p35. A horizontal axis illustrated in FIG. 5 indicates an X coordinate, and a vertical axis indicates a Y coordinate. In this embodiment, the XY coordinate system had a region of 600×340.

Position coordinates of the respective reference points p01 to p35 are stored in the storage unit 22.

Further, a timing of the calibration is not limited, but in this description, the calibration is performed prior to shipment of the input device 1.

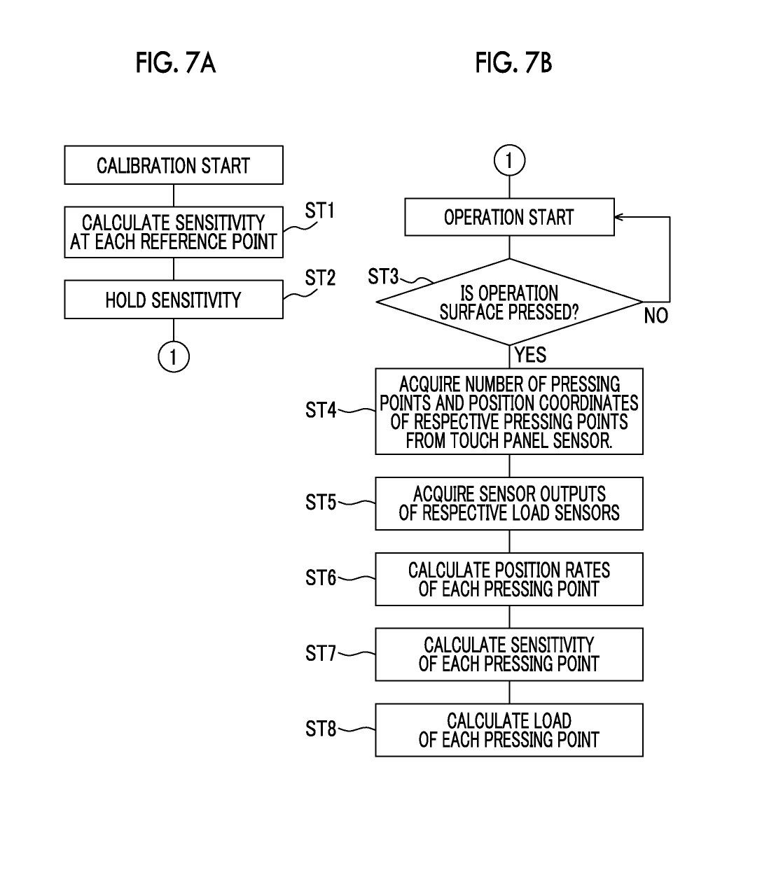

Prior to the shipment, the respective reference points p01 to p35 are sequentially pressed with a constant load. That is, the respective reference points p01 to p35 are sequentially pressed one by one with a constant load instead of being simultaneously pressed. In this case, it is possible to obtain sensor outputs from the respective load sensors A to D. In step ST1 illustrated in FIG. 7A, the calculation unit 23 of the control unit 2 calculates sensitivities at the respective reference points p01 to p35 in the respective load sensors A to D. Here, since the sensor output (LSB) and the load (g) of the respective load sensors A to D are known, the sensitivity (LSB/g) can be obtained by dividing the sensor output by the load. Here, the unit LSB of the sensor output is a minimum unit of a digital output, and is a value calculated by a reference voltage and resolution. When the sensor output is an analog output, the unit of the output is generally a voltage.

Also, Table 1 below including the position coordinates and the sensitivities of the reference points p01 to p35 is stored in the storage unit 22 (step ST2 of FIG. 7A).

TABLE 1

| | Coordinate | | Sensitivity (LSB/g) | | | |
|---|---|---|---|---|---|---|
| Position | X | Y | A | B | C | D |
| p01 | 0 | 0 | 0.19 | 0.06 | 0.01 | 0.05 |
| p02 | 100 | 0 | 0.18 | 0.23 | 0.03 | 0.14 |
| p03 | 200 | 0 | 0.13 | 0.51 | 0.06 | 0.19 |
| p04 | 300 | 0 | 0.07 | 0.77 | 0.07 | 0.21 |
| p05 | 400 | 0 | 0.05 | 0.50 | 0.15 | 0.19 |
| p06 | 500 | 0 | 0.04 | 0.22 | 0.19 | 0.12 |
| p07 | 600 | 0 | 0.00 | 0.07 | 0.19 | 0.02 |
| p08 | 0 | 85 | 0.52 | 0.11 | 0.03 | 0.13 |
| p09 | 100 | 85 | 0.54 | 0.36 | 0.07 | 0.36 |
| p10 | 200 | 85 | 0.34 | 0.71 | 0.18 | 0.58 |
| p11 | 300 | 85 | 0.23 | 0.89 | 0.26 | 0.68 |
| p12 | 400 | 85 | 0.14 | 0.69 | 0.42 | 0.57 |
| p13 | 500 | 85 | 0.04 | 0.36 | 0.58 | 0.40 |
| p14 | 600 | 85 | 0.02 | 0.10 | 0.59 | 0.15 |
| p15 | 0 | 170 | 0.75 | 0.10 | 0.01 | 0.17 |
| p16 | 100 | 170 | 0.68 | 0.37 | 0.10 | 0.56 |
| p17 | 200 | 170 | 0.46 | 0.63 | 0.20 | 0.88 |
| p18 | 300 | 170 | 0.27 | 0.74 | 0.35 | 1.06 |
| p19 | 400 | 170 | 0.16 | 0.63 | 0.57 | 0.91 |
| p20 | 500 | 170 | 0.07 | 0.33 | 0.74 | 0.54 |
| p21 | 600 | 170 | 0.11 | 0.09 | 0.43 | 0.12 |
| p22 | 0 | 255 | 0.53 | 0.04 | 0.01 | 0.16 |
| p23 | 100 | 255 | 0.54 | 0.24 | 0.06 | 0.59 |
| p24 | 200 | 255 | 0.40 | 0.40 | 0.16 | 1.07 |
| p25 | 300 | 255 | 0.27 | 0.47 | 0.27 | 1.32 |
| p26 | 400 | 255 | 0.15 | 0.41 | 0.43 | 1.05 |
| p27 | 500 | 255 | 0.06 | 0.26 | 0.61 | 0.62 |
| p28 | 600 | 255 | 0.10 | 0.08 | 0.31 | 0.12 |
| p29 | 0 | 340 | 0.24 | 0.03 | 0.00 | 0.13 |
| p30 | 100 | 340 | 0.22 | 0.09 | 0.05 | 0.48 |
| p31 | 200 | 340 | 0.16 | 0.14 | 0.08 | 0.94 |
| p32 | 300 | 340 | 0.11 | 0.18 | 0.12 | 1.40 |
| p33 | 400 | 340 | 0.07 | 0.15 | 0.20 | 0.98 |
| p34 | 500 | 340 | 0.00 | 0.10 | 0.26 | 0.50 |
| p35 | 600 | 340 | −0.02 | 0.03 | 0.28 | 0.14 |

When the reference point p01 (the lattice point of the position coordinate (X, Y)) is pressed, the sensitivity of the load sensor A is highest and the sensitivity of the load sensor C is lowest, as shown in Table 1. This is because a distance between the reference point p01 and the load sensor A is shortest in comparison with the load sensors B to D, and a distance between the reference point p01 and the load sensor C is longest in comparison with the load sensors A, B, and D, as illustrated in FIG. 5. Thus, the sensitivity becomes high as the load sensor is closer to the pressing point and becomes small as the load sensor is farther from the pressing point.

The calibration ends through steps ST1 and ST2 of FIG. 7A. Thus, the calibration of the input device 1 has been completed at the time of shipment. Further, a user who purchases the input device 1 is able to execute the calibration, but this case will be described below.

FIG. 7B illustrates a step until load calculation of each pressing point when the user purchasing the input device 1 simultaneously presses the operation surface 4a at a plurality of pressing points.

In step ST3 of FIG. 7B, it is detected whether the operation surface 4a has been pressed. The operation surface 4a may be determined to have been pressed, for example, when a total amount of change in the sensor outputs of the respective load sensors A to D is a predetermined size or more or when the position is detected in the capacitive touch panel sensor 4.

Further, the pressing point may be one point. However, in the following description, pressing points Ito IV are four points, as illustrated in FIG. 5.

In step ST4, the number of pressing points and the position coordinates of the respective pressing points I to IV are acquired from the capacitive touch panel sensor 4.

In this embodiment, since the capacitive touch panel sensor 4 is used as the position detection sensor, it is possible to simply and appropriately detect the number of pressing points and the position coordinates of the respective pressing points I to IV. That is, the capacitive touch panel sensor 4 is configured to include, for example, a large number of X electrodes and a large number of Y electrodes, and a change in capacitance between the operation body such as a finger and the X electrode close to the operation body and a change in capacitance between the operation body and the Y electrode close to the operation body occur. Thus, by detecting the electrodes in which the capacitance change occurs, it is possible to detect the number of pressing points and the position coordinates of the respective pressing points I to IV even when a plurality of pressing points are simultaneously pressed. The position coordinates of the respective pressing points I to IV are shown in Table 2.

TABLE 2

| | Coordinate | |
|---|---|---|
| Pressing point | X | Y |
| I | 140 | 290 |
| II | 450 | 35 |
| III | 50 | 140 |
| IV | 540 | 230 |

Then, the sensor outputs of the respective load sensors A to D are acquired in step ST5 of FIG. 7B. The sensor outputs of the respective load sensors Ito IV are shown in Table 3.

TABLE 3

| | Output |
|---|---|
| Sensor | (LSB) |
| A | 94 |
| B | 151 |
| C | 152 |
| D | 208 |

The position coordinate of the pressing point I is shown as a specific numerical value in Table 2, but is hereinafter indicated as (x1, y1). In addition, the position coordinate of the pressing point II is indicated as (x2, y2), the position coordinate of the pressing point III is indicated as (x3, y3), and the position coordinate of the pressing point IV is indicated as (x4, y4).

Here, for example, the pressing point is assumed to be only one point of I. In this case, the sensor output (Out A) of the load sensor A, the sensor output (Out B) of the load sensor B, the sensor output (Out C) of the load sensor C, and the sensor output (Out D) of the load sensor D are expressed as a product of the load of the pressing point I and the sensitivities of the respective load sensors A to D and are shown in Equation 1 below.

Out_{—}A=a(x1,y1)·Z(1)

Out_{—}B=b(x1,y1)·Z(1)

Out_{—}C=c(x1,y1)·Z(1)

Out_{—}D=d(x1,y1)·Z(1) [Equation 1]

Here, a(x1, y1) in Equation 1 indicates the sensitivity of the load sensor A when the pressing point I is pressed, b (x1, y1) indicates the sensitivity of the load sensor B, c (x1, y1) indicates the sensitivity of the load sensor C, and d (x1, y1) indicates the sensitivity of the load sensor D. Further, Z(1) indicates the load when the pressing point I is pressed.

Therefore, when the pressing points are four points Ito IV as illustrated in FIG. 5, the sensor output (Out A) of the load sensor A, the sensor output (Out B) of the load sensor B, the sensor output (Out C) of the load sensor C, and the sensor output (Out D) of the load sensor D are shown in Equation 2 below.

Out A=a(x1, y1)·Z(1) a(x2, y2)·Z(2)+a(x3, y3)·Z(3)+a(x4, v4)·Z(4)

Out_{—}B=b(x1, y1)·Z(1)+b(x2, y2)·Z(2)+b(x3, y3)·Z(3)+b(x4, y4)·Z(4)

Out_{—}C=c(x1, y1)·Z(1)+c(x2, y2)·Z(2)+c(x3, y3)·Z(3)+c(x4, y4)·Z(4)

Out_{—}D=d(x1, y1)·Z(1)+d(x2, y2)·Z(2)+d(x3, y3)·Z(3)+d(x4, y4)·Z(4) [Equation 2]

The sensor output (Out A) of the load sensor A in Equation 2 will be described. Sensitivity a(x1, y1) is sensitivity of the load sensor A when it is assumed that only the pressing point I is pressed, sensitivity a(x2, y2) is sensitivity of the load sensor A when it is assumed that only the pressing point II is pressed, sensitivity a(x3, y3) is sensitivity of the load sensor A when it is assumed that only the pressing point III is pressed, and sensitivity a(x4, y4) is sensitivity of the load sensor A when it is assumed that only the pressing point IV is pressed. Further, a load Z(1) is a load when the pressing point I is pressed, a load Z(2) is a load when the pressing point II is pressed, a load Z(3) is a load when the pressing point III is pressed, and a load Z(4) is a load when the pressing point IV is pressed. Therefore, the sensor output (Out A) of the load sensor A may be expressed as a sum of respective products of the sensitivities a(x1, y1) to a(x4, y4) of the respective pressing points and the loads Z(1) to Z(4) of the respective pressing points. The sensor output (Out B) of the load sensor B, the sensor output (Out C) of the load sensor C, and the sensor output (Out D) of the load sensor D shown in Equation 2 may be considered similarly to the sensor output of the load sensor A. Further, the sensitivities shown in Equation 2 have different values. For example, in terms of the sensor output (Out A) of the load sensor A, since the pressing point is close to the load sensor A in an order of III, I, and II, and the pressing point farthest from the load sensor A is IV, it can be predicted that the sensitivity a(x3, y3) is maximum and the sensitivity a(x4, x4) is minimum. Further, in terms of the sensitivities a(x1, y1), b(x2, y2), c(x3, y3), and d(x4, y4) in the respective load sensors A to D at the pressing point I, since the load sensors are close to the pressing point I in an order of D, A, and B, and the load sensor farthest from the pressing point I is C, it can be predicted that the sensitivity d(x1, y1) is maximum and the sensitivity c(x1, x1) is minimum.

Here, the pressing point I is considered. As illustrated in FIG. 6, the pressing point I exists within a smallest lattice (a smallest rectangular region) 30 connecting four reference points p23, p24, p30, and p31 that are close to the pressing point I.

In this embodiment, in step ST6 illustrated in FIG. 7B, a position rate of the pressing point I within the smallest lattice 30 is obtained by the calculation unit 23 of the control unit 2, based on a position coordinate of the pressing point I and position coordinates of the respective reference points p23, p24, p30, and p31 that are close to the pressing point I. Here, the position coordinates of the respective reference points p23, p24, p30, and p31 and the position coordinate of the pressing point I are acquired from the storage unit 22, and a table thereof is shown in Table 4 below.

TABLE 4
Point I

| | Coordinate | | Sensitivity (LSB/g) | | | |
|---|---|---|---|---|---|---|
| Pressing point | X | Y | A | B | C | D |
| p23 | 100 | 255 | 0.54 | 0.24 | 0.06 | 0.59 |
| p24 | 200 | 255 | 0.40 | 0.40 | 0.16 | 1.07 |
| p30 | 100 | 340 | 0.22 | 0.09 | 0.05 | 0.48 |
| p31 | 200 | 340 | 0.16 | 0.14 | 0.08 | 0.94 |
| I | 140 | 290 | 0.37 | 0.22 | 0.09 | 0.73 |
| (u,v) | 0.400 | 0.412 | | | | |

Sensitivities of the respective reference points p23, p24, p30, and p31 are extracted from Table 1 showing the values acquired by the calibration.

Further, sensitivities of the respective load sensors A to D at the pressing point I are shown in Table 4, but these sensitivities are unclear at present. Position rates u and v of the pressing point I in the smallest lattice 30 are obtained so as to obtain the sensitivities of the respective load sensors A to D at this pressing point I. The position rate u in the X direction and the position rate v in the Y direction were obtained using Equation 3 below.

u=(I(x)−p23(x))/(p24(x)−p23(x))=(140−100)/(200−100)=40/100=0.4

v=(I(y)−p23(y))/(p30(y)−p23(y)=(290−255)/(340−255)=35/85=0.412 [Equation 3]

According to Equation 3, the position rate u in the X direction of the pressing point I within the smallest lattice 30 was obtained using the X coordinate of the reference point p23 as a reference position. Further, the position rate v in the Y direction of the pressing point I within the smallest lattice 30 was obtained using the Y coordinate of the reference point p23 as a reference position.

As shown in Equation 3, the position rate in the X direction was 0.4, and the position rate in the Y direction was 0.412. That is, when a length in the X direction within the smallest lattice 30 illustrated in FIG. 6 is assumed to be 1, the pressing point I is present in a position of I′ apart by a length of a rate 0.4 in an X1 direction from the position of the reference point p23, and when a length in the Y direction within the smallest lattice 30 illustrated in FIG. 6 is assumed to be 1, the pressing point I is present in a position (x1, y1) apart by a length of a rate 0.412 in a Y1 direction from the position of I′.

Further, the position rates u and v of the pressing point II, the pressing point III, and the pressing point IV within the smallest lattice surrounded by four reference points that are close to the pressing point II, the pressing point III, and the pressing point IV can be similarly obtained according to Equation 3.

The position coordinates of the reference point p5, p6, p12, and p13, the sensitivities of the respective load sensors A to D at the respective reference points, the position coordinate of the pressing point II, and the sensitivities of the respective load sensors A to D at the pressing point II, which are used to obtain the position rates u and v of the pressing point II, and the position rates u and v of the pressing point II within the smallest lattice are shown in Table 5 below.

The position coordinates of the reference point p8, p9, p15, and p16, the sensitivities of the respective load sensors A to D at the respective reference points, the position coordinate of the pressing point III, and the sensitivities of the respective load sensors A to D at the pressing point III, which are used to obtain the position rates u and v of the pressing point III, and the position rates u and v of the pressing point III within the smallest lattice are shown in Table 6.

The position coordinates of the reference point p20, p21, p27, and p28, the sensitivities of the respective load sensors A to D at the respective reference points, the position coordinate of the pressing point IV, and the sensitivities of the respective load sensors A to D at the pressing point IV, which are used to obtain the position rates u and v of the pressing point IV, and the position rates u and v of the pressing point IV within the smallest lattice are shown in Table 7.

TABLE 5
Point II

| | Coordinate | | Sensitivity (LSB/g) | | | |
|---|---|---|---|---|---|---|
| Pressing point | X | Y | A | B | C | D |
| P5 | 400 | 0 | 0.05 | 0.50 | 0.15 | 0.19 |
| p6 | 500 | 0 | 0.04 | 0.22 | 0.19 | 0.12 |
| p12 | 400 | 85 | 0.14 | 0.69 | 0.42 | 0.57 |
| p13 | 500 | 85 | 0.04 | 0.36 | 0.58 | 0.40 |
| II | 450 | 35 | 0.06 | 0.43 | 0.31 | 0.29 |
| (u,v) | 0.500 | 0.412 | | | | |

TABLE 6
Point III

| Pressing | Coordinate | | Sensitivity (LSB/g) | | | |
|---|---|---|---|---|---|---|
| point | X | Y | A | B | C | D |
| P8 | 0 | 85 | 0.52 | 0.11 | 0.03 | 0.13 |
| P9 | 100 | 85 | 0.54 | 0.36 | 0.07 | 0.36 |
| p15 | 0 | 170 | 0.75 | 0.10 | 0.01 | 0.17 |
| p16 | 100 | 170 | 0.68 | 0.37 | 0.10 | 0.56 |
| III | 50 | 140 | 0.65 | 0.23 | 0.05 | 0.32 |
| (u,v) | 0.500 | 0.647 | | | | |

TABLE 7
Point IV

| Pressing | Coordinate | | Sensitivity (LSB/g) | | | |
|---|---|---|---|---|---|---|
| point | X | Y | A | B | C | D |
| p20 | 500 | 170 | 0.07 | 0.33 | 0.74 | 0.54 |
| p21 | 600 | 170 | 0.11 | 0.09 | 0.43 | 0.12 |
| p27 | 500 | 255 | 0.06 | 0.26 | 0.61 | 0.62 |
| p28 | 600 | 255 | 0.10 | 0.08 | 0.31 | 0.12 |
| IV | 540 | 230 | 0.08 | 0.20 | 0.53 | 0.40 |
| (u,v) | 0.400 | 0.706 | | | | |

Then, in step ST7 of FIG. 7B, the sensitivities of the respective load sensors A to D at the respective pressing points Ito IV are calculated by the calculation unit 23 of the control unit 2. Hereinafter, the sensitivity at the pressing point I will be described.

In this embodiment, it is assumed that the sensitivity changes in proportion to a rate of lengths between the reference point p23 and the reference point p24, between the reference point p23 and the reference point p30, between the reference point p30 and the reference point p31, and between the reference point p24 and the reference point p31, which surround the pressing point I. That is, for example, when the sensitivity (see Table 4) of the load sensor A at the pressing point I is considered, the sensitivity at the reference point p23 is 0.54 and the sensitivity at the reference point p24 is 0.40, and thus, it is assumed that the sensitivity of the load sensor A at a middle point between the reference point p23 and the reference point p24 is 0.47.

As described above, the sensitivity becomes high (low) as the pressing point is closer to the load sensor (farther from the load sensor). In this case, even when the sensitivity is regarded as changing as a linear function in the X direction and the Y direction within the smallest lattice 30 illustrated in FIG. 6 (for example, sensitivity at a middle point between the reference point p23 and the reference point p24 is regarded as an intermediate value between the reference point p23 and the reference point p24, as described above) to obtain the sensitivities of the respective load sensors A to D at the pressing point I, it is possible to suppress a difference (sensitivity error) between actual sensitivity at the pressing point I and the sensitivity calculated at the pressing point I to be small.

As described above, if it is assumed that the sensitivities of the respective load sensors A to D within the smallest lattice 30 are obtained by performing proportional conversion on the sensitivities at the respective reference points p23, p24, p30, and p31 constituting the smallest lattice 30, the sensitivity in the position of I′ illustrated in FIG. 6 can be shown as { sensitivity (p24)−sensitivity (p23)}·u+sensitivity (p23), and the sensitivity in a position of I″ can be shown as {sensitivity (p31)−sensitivity (p30)}·u+sensitivity (p30).

Also, since the pressing point is in a position obtained by moving at the position rate v in the Y1 direction from the position of I′, the sensitivity at the pressing point I can be shown in Equation 4 below.

Sensor A sensitivity (point 1)=|(Sensor A sensitivity (p24)−Sensor A sensitivity (p23)*u+Sensor A sensitivity (p23)|+v|((Sensor A sensitivity (p31)−Sensor A sensitivity (p30)*u+Sensor A sensitivity (p30))−((Sensor A sensitivity (p24)−Sensor A sensitivity (p23))*u+Sensor A sensitivity (p23))| [Equation 4]

Further, Equation 4 shows sensitivity of the load sensor A at the pressing point I. The sensitivities of the load sensor A at the respective pressing points II to IV and the load sensors B to D at the pressing points I to IV are also able to be obtained according to Equation 4.

Accordingly, the sensitivities of the load sensors A to D at the respective pressing points I to IV were able to be obtained. The position coordinates of the respective pressing points I to IV, the sensitivities of the respective load sensors A to D at the respective pressing points I to IV, and the sensor outputs of the respective load sensors A to D are collectively shown in Table 8.

TABLE 8

| | | | | | | | | Sensor |
|---|---|---|---|---|---|---|---|---|
| Pressing | Coordinate | | Sensitivity (LSB/g) | | | | Load | output |
| point | X | Y | A | B | C | D | (g) | (LSB) |
| I | 140 | 290 | 0.37 | 0.22 | 0.09 | 0.73 | Z(1) | 94 |
| II | 450 | 35 | 0.06 | 0.43 | 0.31 | 0.29 | Z(2) | 151 |
| III | 50 | 140 | 0.65 | 0.23 | 0.05 | 0.32 | Z(3) | 152 |
| IV | 540 | 230 | 0.08 | 0.20 | 0.53 | 0.40 | Z(4) | 208 |

“A” at the pressing point I in column “sensitivity” shown in Table 8 indicates sensitivity of the load sensor A at the pressing point I and corresponds to sensitivity a(x1, y1) in Equation 2, “B” at the pressing point I corresponds to sensitivity b(x1, y1) in Equation 2, “C” at the pressing point I corresponds to sensitivity c(x1, y1) in Equation 2, and “D” at the pressing point I corresponds to sensitivity d(x1, y1) in Equation 2. The same applies to a relationship between “A” to “D” at the respective pressing points II-IV in column “sensitivity” in Table 8 and the sensitivities a(x2, y2) to d(x4, y4) shown in Equation 2.

Further, when each sensor output and each sensitivity shown in Table 8 are applied to Equation 2, Equation 5 below is obtained.

### ti 0.37Z(1)+0.06Z+0.65Z(3)+0.08Z(4)=94

0.22Z(1)+0.43Z(2)+0.23Z(3)+0.20Z(4) 151

0.09Z(1)+0.31Z(2)+0.05Z(3)+0.53Z(4)=152

0.73Z(1)+0.29Z(2)+0.32Z(3)+0.40Z(4)=208 [Equation 5]

Here, unknowns are four loads Z(1) to Z(4). Meanwhile, since a simultaneous linear equation includes four equations as shown in Equation 5, Equation 5 is able to be solved and the respective loads Z(1) to Z(4) are able to be obtained. A calculation in Equation 5 is performed by the calculation unit 23 of the control unit 2.

A result of solving Equation 5 showed that the load Z(1) at the pressing point I was 100, the load Z(2) at the pressing point II was 202, the load Z(3) at the pressing point III was 50, and the load Z(4) at the pressing point IV was 149 (step ST8 in FIG. 7B).

As described above, in this embodiment, the sensitivities at the plurality of reference points p01 to p35 on the operation surface 4a are held by the calibration in advance (FIG. 7A and Table 1). Also, if the user simultaneously presses a plurality of points (the plurality of pressing points Ito IV) on the operation surface 4a, the position rates u and v of the respective pressing points Ito IV are first obtained (Tables 4 to 7 and step ST6 in FIG. 7B). The position rates u and v can be obtained from the position coordinates of the respective pressing points I to IV obtained in step ST4 of FIG. 7B and the position coordinates at a plurality of reference points constituting the smallest lattice to be close to the respective pressing points Ito IV, which are extracted from Table 1. Then, the sensitivities at the respective pressing points I to IV are obtained based on the sensitivity at the respective reference points constituting the smallest lattice and the position rates u and v of the respective pressing points I to IV (Tables 4 to 7, and step ST7 in FIG. 7B). Also, it is possible to calculate the load Z of the respective pressing points Ito IV based on the sensitivities at the respective pressing points I to IV and the sensor sensitivities of the respective load sensors A to D (Table 8 and step ST8 in FIG. 7B).

Thus, in this embodiment, it is possible to appropriately and simply obtain the loads of a plurality of pressing points I to IV simultaneously pressed, without using a complicated calculation.

Particularly, according to this embodiment, it is possible to obtain the loads of the respective pressing points even when the number of the plurality of simultaneously pressed pressing points is equal to the number of load sensors A to D. That is, in the above-described embodiment, since the four load sensors A to D are provided, it is possible to obtain the loads Z of the respective pressing points I to IV even when the operation surface 4a is simultaneously pressed at four points. The simultaneous linear equation including the same number of equations as the number of load sensors as shown in Equations 2 and 5 can be obtained, unknowns in this case are only the loads of the respective pressing points, and since the number of unknowns is equal to the number of equation in the simultaneous linear equation, the simultaneous linear equation can be solved. Further, as a matter of course, when the four load sensors A to D are provided, it is possible to obtain the load of each pressing point using the above-described equation even when the number of pressing points on the operation surface 4a is 1 to 3.

Further, the number of load sensors is not particularly limited as long as the number of load sensors is 2 or more. However, when the number of pressing points is greater than 3, a calculation when a load of each pressing point is obtained is complicated or disabled in a method of the related art, and thus, it is preferable for the number of load sensors to be 4 or more.

The calibration illustrated in FIG. 7A may be performed before shipment or may be performed by a user after the shipment. When the user performs the calibration, the respective reference points p01 to p35 illustrated in FIG. 5 may be at least displayed on the operation surface 4a illustrated in FIG. 1, and the user sequentially presses the respective reference points p01 to p35 using his or her finger or a pen so that the sensitivities in the respective reference points p01 to p35 is obtained. It is preferable that when the reference points are pressed, sound or display for informing the user that the sensitivity detection is completed is performed if a predetermined load arrives.

Further, after the calibration is performed before shipment, the user is also able to perform the calibration. In this case, the user may be caused to press all the reference points p01 to p35 illustrated in FIG. 5, but the user is caused to press some of the reference points and the sensitivities at the pressed reference points are obtained. In this case, it is detected what extent of a sensitivity error is generated in comparison with sensitivity data obtained by the calibration before the shipment. The sensitivities at the other reference points can be obtained while matching the sensitivity data obtained by the calibration before the shipment with a value of the sensitivity error obtained by pressing the specific reference points.

In this embodiment, when the position rates u and v of the respective pressing points I to IV are to be obtained, it is preferable to obtain the position rate u in the X direction and the position rate v in the Y direction of the respective pressing points I to IV within the smallest lattice surrounded by the four reference points close to the respective pressing points I to IV. For example, it is possible to also obtain the position rates u and v of the pressing point I within a slightly larger region using the reference points p15, p18, p29, and p32 that are lattice points of the slightly larger region without using the reference points p23, p24, p30, and p31 constituting the smallest lattice, for example, so as to obtain the position rates u and v of the pressing point I. However, since a sensitivity obtained through proportional conversion from the sensitivities at the respective reference points surrounding the pressing point I using the position rates u and v is regarded as the sensitivity at the pressing point I as described above, when the region surrounding the pressing point I is increased, a sensitivity error at the pressing point I is easily correspondingly generated. Therefore, it is possible to preferably reduce the sensitivity error by obtaining the sensitivities at the respective pressing points I to IV in the region surrounded by the reference points close to the respective pressing points I to IV.

Further, in this embodiment, it is preferable that the respective lattice points obtained through crossing in the X direction and the Y direction in the XY coordinate system are the reference points p01 to p35, and the position rates u and v at the respective pressing points Ito IV in the smallest lattice surrounded by the four references close to the respective pressing points I to IV are obtained. For example, each crossing point obtained by obliquely crossing the X direction and the Y direction may be the reference point. However, in this configuration, a shape obtained by connecting the four reference points close to the pressing point around the pressing point in a straight line shape is a diamond shape rather than the rectangular or square lattice shape as illustrated in FIG. 5. In this case, it is necessary to obtain the position rates of the pressing point using a coordinate in an oblique direction, the calculation of the position rates are easily complicated, and the sensitivity error is easily generated. Meanwhile, by using the lattice points obtained through crossing in the X direction and the Y direction as the reference points p01 to p35 and obtaining the position rates of the respective pressing points I to IV within the smallest lattice as in this embodiment, it is easy to simply calculate the position rates u and v, and it is possible to reduce a calculation burden of the control unit 2, and to speedily and accurately obtain the loads of the respective pressing points I to IV. Further, it is possible to reduce the sensitivity error at the respective pressing points I to IV.

The input device (touch panel) 1 in this embodiment is applicable to a portable telephone, a portable information processing device, a portable storage device, a portable game device, or the like.

It should be understood by those skilled in the art that various modifications, combinations, sub-combinations and alterations may occur depending on design requirements and other factors insofar as they are within the scope of the appended claims of the equivalents thereof.

What is claimed is:

1. An input device comprising a position detection sensor capable of detecting a pressing position on an operation surface, a plurality of load sensors configured to output a sensor output depending on a load, and a control unit configured to calculate respective loads at a plurality of pressing points simultaneously pressed on the operation surface through the following process:
(1) calculating sensitivity at a plurality of different reference points on the operation surface from the sensor output of each load sensor, and holding the sensitivity,
(2) obtaining the sensor output from each load sensor and detecting a position coordinate of each pressing point from the position detection sensor when the operation surface is simultaneously pressed at the plurality of pressing points,
(3) obtaining position rates of each pressing point within a region surrounded by the plurality of reference points close to each pressing point based on the position coordinates of each pressing point and each reference point,
(4) obtaining the sensitivity of each pressing point based on the sensitivity of each reference point used in (3) and the position rates of each pressing point, and
(5) calculating the load of each pressing point based on the sensitivity of each pressing point obtained in (4) and the sensor output of each load sensor obtained in (2).

2. The input device according to claim 1,
wherein, in an XY coordinate system, each lattice point obtained through crossing in an X direction and an Y direction is the reference point, and in (3), a position rate u in the X direction and a position rate v in the Y direction of each pressing point within a smallest lattice surrounded by four reference points close to each pressing point are obtained.

3. The input device according to claim 1,
wherein 4 or more load sensors are provided.

4. A method of detecting a pressing point in an input device including a position detection sensor capable of detecting a pressing position on an operation surface, a plurality of load sensors configured to output a sensor output depending on a load, and a control unit configured to calculate respective loads at a plurality of pressing points simultaneously pressed on the operation surface, the method comprising steps of:
(1) calculating sensitivity at a plurality of different reference points on the operation surface from the sensor output of each load sensor, and holding the sensitivity;
(2) obtaining the sensor output from each load sensor and detecting a position coordinate of each pressing point from the position detection sensor when the operation surface is simultaneously pressed at the plurality of pressing points;
(3) obtaining, in the control unit, position rates of each pressing point within a region surrounded by the plurality of reference points close to each pressing point based on the position coordinates of each pressing point and each reference point;
(4) obtaining, in the control unit, the sensitivity of each pressing point based on the sensitivity of each reference point used in (3) and the position rates of each pressing point; and
(5) calculating, in the control unit, the load of each pressing point based on the sensitivity of each pressing point obtained in (4) and the sensor output of each load sensor obtained in (2).
